(19) United States
(12) Patent Application Publication
(10) Pub. No.: US 2015/0273771 A1
(43) Pub. Date: Oct. 1, 2015

(54) METHOD AND APPARATUS FOR PRODUCING PREFORMS FOR THE PRODUCTION OF A ROTOR BLADE

(71) Applicant: WOBBEN PROPERTIES GMBH, Aurich (DE)

(72) Inventors: Joachim Schreiber, Bardowick/Lueneburg (DE); Johannes Kannenberg, Aurich (DE)

(21) Appl. No.: 14/437,422

(22) PCT Filed: Oct. 14, 2013
(86) PCT No.: PCT/EP2013/071405

§ 371 Date: Apr. 21, 2015

(30) Foreign Application Priority Data
Oct. 22, 2012 (DE) 10 2012 219 267.0

(51) Int. Cl. B29C 70/38; B29C 70/54

(52) U.S. Cl. CPC B29C 70/386; B29C 70/54; B29K 2075/00

(57) ABSTRACT

The invention relates a method of producing a rotor blade, according to which a preform is produced as a semi-finished textile product from a number of material sheets of textured laid scrim mats, preferably for use in a subsequent vacuum infusion comprising the steps of: provision of a mold for the preform in a laying frame, provision of a textured laid scrim mat in the form of a roll of the material sheet on a laying roll, automatic rolling out of the textured laid scrim mat and automatic application of an adhesive to the textured laid scrim mat in the mold in the laying frame.

### BACKGROUND

1. Technical Field

The invention relates to a method of producing a rotor blade, wherein a preform is produced as a semi-finished textile product from a number of material sheets of textured laid scrim mats. The invention further relates to an apparatus for producing preforms for the production of a rotor blade.

2. Description of the Related Art

An initially mentioned method is commonly performed as a manual lamination method. In this context, a number of material sheets of textured laid scrim mats and other semi-finished textile products, such as fabric, layer or fiber mats, are manually placed into a form. If needed, reinforcements or sandwich materials are inserted. The semi-finished fiber products illustrated in such a way can be directly impregnated with synthetic resin; it has been preferred to attach a semi-finished textile product produced in such a way and further to impregnate it by way of a vacuum infusion with a synthetic resin or other duroplast and/or elastomer and/or thermoplast for the illustration of a matrix. The above referenced manual lamination method is in particular used to produce rotor blades for a wind energy plant. The semi-finished textile product is produced as a preform with the named manual lamination method in a mold, taken out of the form and preferably transferred to a subsequent vacuum infusion to impregnate the semi-finished product.

In this context, it can be a problem that the manually laid out textured laid scrim mats are attached with comparatively high effort. A manual lamination method is conditionally exposed to quality management or process optimization. In particular, an automation of the method has so far shown to be highly problematic. Methods for the illustration of fiber composite material which are easier to automate, such as die casting or sheet molding, cannot be used for a fiber composite with the size of a rotor blade such as in a wind power installation. Desirable is an automated method of producing a preform for the production of a rotor blade.

Generally known from prior art are methods of illustrating textured laid scrims in concept. These provide for a cut in the context of a laying construct, whereby the cut material is subsequently gripped by a gripper system, singled out or positioned to be attached on a band or a deposit table with other textured laid scrims; subsequently, the assemblage of combined textured laid scrims has to be transported again and be brought into a form and be assembled thereafter. Such a method, which is known in principle, is not suited to be used in large construction components such as a rotor blade for a wind power installation.

### BRIEF SUMMARY

One or more embodiments are directed to a method of producing a rotor blade, whereby a preform is produced as a semi-finished textile product from a number of material sheets of textured laid scrim mats.

One embodiment of method includes the following steps:
providing a mold for the preform in a laying frame;
providing a textured laid scrim mat of the material sheet in rolled up form on a laying roll;
automated roll-out of the structural fabric mat;
automated application of an adhesive on the textured laid scrim mats in the mold in the laying frame.

In particular, it can be provided in a further embodiment that the automated roll-out is performed while rolling out the laying roll above the mold and while rolling up the material sheet of the laying roll and while simultaneously inserting the textured laid scrim mat in the mold in the laying frame.

Especially preferred, the provision of a textured laid scrim mat is done by attaching the laying roll to a roll tool holder of the laying frame. The adhesive is in particular applied while inserting the adhesive into an adhesive applicator on an adhesive tool holder of the laying frame.

Another embodiment of the invention, in particular in consideration of the above referenced further embodiment, also leads to an apparatus for producing preforms for the production of a rotor blade with which a preform as a semi-finished textile product can be produced from a number of material sheets of textured laid scrim mats and which is formed with a laying frame comprising:
a mount adapted to provide a mold for the preform in the laying frame;
a roll tool holder, designed to provide a textured laid scrim mat in rolled up form of the material sheet on a laying roll and designed for the automated roll-up of the textured laid scrim mat in the mold in the laying frame;
an adhesive tool holder, designed for the automated application of an adhesive on the textured laid scrim mat in the mold in the laying frame;
a guide system to guide tool holders individually or in combination above the mold.

The automated insertion of textured laid scrim mats in a mold offers a basis for the automated production of a preform. Furthermore, one or more embodiments of the invention recognized that an automated method has to be conducted directly on the mold. In addition, a textured laid scrim mat of the material sheet, in particular in consideration of the suitability for the production of a rotor blade is to be provided in rolled up form on a laying roll.

According to one embodiment, the textured laid scrim mat is rolled out automatically and an adhesive is applied automatically on the textured laid scrim mat in the mold in the laying frame. The concept of the invention proves to be superior compared to the previously generally known automation approaches. In some embodiments, transport ways for the production of the preform are practically omitted, because it can practically be completely produced in the laying frame as a semi-finished product.

The concept of the invention rather follows the approach to provide a number of suitable movable tools, however at least a roll tool holder and an adhesive tool holder, to perform the automated roll out of the textured laid scrim mat and the automated application of the adhesive. The concept can be applied flexibly, where needed also with a variation of the order or with a simultaneous performance of the automation steps. In addition, it shows that the automated method makes quality management as well as process optimization possible. The automated method is in particular also suited for the integration into an automated storing of cut textured laid scrim mats in rolled up form prior to the provision of the textured laid scrim mat.

Preferred further embodiments of the invention can be found in the sub-claims and provide in detail advantageous possibilities to further embody the concept of the invention in regard to the method and the apparatus with further advantages.

Preferably, a single textured laid scrim mat can be provided in rolled up form on a laying roll. However, more than one textured laid scrim mat can also be provided in rolled up form of one material sheet each on a laying roll; this reduces the effort required for the exchange of the laying rolls or respectively insertion of a laying roll with textured laid scrim mats and output of a laying roll without textured laid scrim mat.

Before the automated roll out of the textured laid scrim mat or respectively after a first partial roll out of the textured laid scrim mat and before a complete roll out of the textured laid scrim mat, it has proven to be advantageous that a textured laid scrim mat is attached to the mold. This proves to be at least advantageous if it is the first textured laid scrim mat. Through this, shifting of the textured laid scrim mat is avoided during the roll out process until the complete unwinding of the material sheet from the laying roll. Thus, the textured laid scrim mat can be inserted at a precise position into the mold.

In the context of an especially preferred further embodiment, the inserted textured laid scrim mat is pressed against the mold and/or against the underlying textured laid scrim mats of the partially completed preform. The pressing of the inserted textured laid scrim mat can occur on the entire area or, as needed, also only in a partial area of the textured laid scrim mat. In particular, a pressing of a partial area such as an edge area or an overlap area of different textured laid scrim mats has proven as advantageous. In particular, the pressed partial area of the textured laid scrim mat includes such partial areas on which an adhesive is applied. The automated method is also applicable in the areas of the preform, which are difficult to access in case of a manual lamination method, i.e., usually areas of strong bends of the mold outside of the horizontal areas that means in particular wall areas of the mold. Here, the pressing can include any type of impressing or similar application of pressure.

The provision of a textured laid scrim mat includes in particular attaching the laying roll to a roll tool holder of the laying frame. The application of an adhesive includes in particular the insertion of the adhesive into an adhesive applicator on an adhesive tool holder of the laying frame.

In the context of a preferred further embodiment, a first textured laid scrim mat is attached to a second textured laid scrim mat in the mold through the application of the adhesive. Depending on the degree of automation, the application of the adhesive can preferably be conducted in an overlap area or in an edge area of each textured laid scrim mat.

In particular, the preform can be completed by repetition of at least the steps of roll-off and application for the number of material sheets of textured laid scrim mats of. In this context, instances can be efficiently connected, alternated or combined advantageously. Thus, as needed, a unidirectional, bidirectional or multi-directional layers can be illustrated with a number of textured laid scrim mats.

In particular, it has proven to be advantageous in the context of the first variable that the roll out and application, in particular also pressing, are performed simultaneously in one instance. In this regard, the laying frame preferably has at least one roll tool holder and an adhesive tool holder, preferably also a pressure tool holder.

In a second variable, the roll out and application, in particular also pressing, can be performed in two instances, in particular in one back and forth movement of a tool holder. For this purpose, it can be provided that only one single tool holder is provided for at the laying frame, which, however, has different tools, such as, for example, exchangeable roll tools, pressure tools and/or adhesive tools. Since an adhesive tool can generally only be changed with a larger effort, it has proven to be advantageous that at least in addition to an adhesive tool holder an additional tool holder, in particular a roll tool holder and/or a pressure tool holder or, however, a tool holder with an exchangeable roll tool and pressure tool, is provided.

In a preferred embodiment of the apparatus according to the invention it has sensor means, which can be moved together with the tool holder and are established to record tensile stress affecting rolled off, not yet pressed sections of the textured laid scrim mat. Through this, it is achieved that the tensile stress caused by the roll tool when rolling off the textured laid scrim mat can be monitored. On the one hand, it is necessary for successfully rolling off the textured laid scrim mat to have a certain tensile stress, so that the mold will not develop creases. On the other hand, the tensile stress must not be too big, since otherwise a reasonable forming of the mold is not possible. Monitoring the tensile stress makes it possible to keep it at a predetermined value, either manually or by means of control or respectively regulating technology.

Further preferred, the sensor means comprise distance sensors, which are adapted to record a sag in the rolled off, not yet pressed sections of the textured laid scrim mat. The degree of the sag is a measurement for the amount of tensile stress; the smaller the tensile stress, the more the free section of the textured laid scrim mat sags between the roll tool and the mold. If sensor means, for example distance sensors, scan a certain section, for example a height section, which is always the same, in sections of the textured laid scrim mat between the roll tool and the mold, the distance between the sensors and the section of the textured laid scrim mat changes with the degree of the sag.

In a further preferred embodiment, the apparatus according to the invention comprises one or several dancer rolls, which are arranged on the tool holder in such a way that the textured laid scrim mat rolled off from the laying roll is redirected one or several times before it is pressed against the mold, whereby preferably one or several dancer rolls have sensor means to record the tensile stress, which affects the rolled off, not yet pressed sections of the textured laid scrim mat. Preferably, the one or several dancer rolls are movable relative to the tool holder. Pursuant to alternative or complementary embodiments, the dancer rolls can be passively movable and/or driven. A change in the tensile stress can be recorded if the dancer roll moves due to a change of the tensile stress affecting the sections of the textured laid scrim mat, which are rolled off, but not yet pressed on. An active moving of the dancer rolls relative to the tool holder makes an increase or decrease of the tensile stress affecting the sections of the textured laid scrim mat possible, since it is redirected to a different extent depending on the location of the dancer roll. Thus, a controlled or respectively regulated moving of the dancer rolls also makes a regulation of the tensile stress possible.

For example, in the context of a first preferred embodiment, in a back and forth sequence of instances along an axis of the preform for the rotor blade, an adhesive can be applied directly before rolling out a textured laid scrim mat. Alternatively, an application of an adhesive can also be performed in addition or alternatively immediately after pressing the textured laid scrim mat.

In an embodiment which may possibly also be applicable, an instance can only be performed unidirectionally and in alternation with an empty instance. Thus, in the same direction an adhesive can be applied immediately after the roll out of a textured laid scrim mat. In an alternative, an application of an adhesive can also be performed immediately before the roll out of the textured laid scrim mat. In the first alternative, it has proven to be advantageous that in addition or alternatively the application of an adhesive is performed immediately after pressing. In the second alternative, it has proven to be advantageous that in addition or alternatively the application of an adhesive is performed immediately after the pressing of the textured laid scrim mats.

As press tool a pressure roll, barrel, sensor or similar has proven to be advantageous. A drum melter has in particular proven to be an advantageous adhesive tool for an adhesive with hot glue or similar substances.

Preferably, the arm or the arms of the press tool holder are arranged on the tool holder and pivotable about at least one, preferably several axes. Alternatively or additionally, the arm or the arms are preferably established to hold the press tool itself in such way that it can be pivoted about one, preferably about several axes.

Pivoting the arms of the press tool holder or pivoting the tools held on the arms themselves significantly improves the adaption of the arms to the geometry of the mold. Moreover, through a side shift of the press tool holder in the case of large mold widths, many different mold geometries can be run reliably without having to provide a correspondingly rigid press tool according to the strongly varying width dependent on the mold.

In a further preferred embodiment, the press tool holder and/or the arm or respectively the arms have sensor means to record the exercised pressing force. It is especially preferred that the press tools can be moved relative to the mold in such a way that their distance to the mold can be readjusted dependent on the recorded pressing force, in particular by means of increasing or decreasing the distance between the mold and the press tool to keep the pressing force in a predetermined range. Increasing the pressing force at a constant roll off speed of the roll tool increases the tensile stress on the textured laid scrim mat. To ensure a roll off process that is as constant as possible, it is advantageous to track the pressing force through targeted readjustment or re-regulating of the press tool position. Thus, even if the mold geometries or the textured laid scrim mat textures change, an essentially always constant pressing force is always ensured.

To perform the method according to at least one embodiment of the invention, the apparatus preferably comprises a control, which is adapted to provide a virtual illustration of the preform and automated movement of a roll tool holder to roll out the textured laid scrim mat and/or automated movement of an adhesive tool holder to apply the adhesive according to one of the movement patterns allocated to the virtual illustration and coordinated with it. Further preferred, the control is designed for an automated storing and removal of laying rolls with an identification and/or safety feature, which can be read without contact, in particular in the form of a RFID element.

The guide system is preferably designed in form of rods with a rail; as an advantage, the rail is adjusted to an outer form of the mold.

In the context of an especially preferred further embodiment, the method comprises another step: providing a virtual illustration of the preform. When using the virtual illustration, a tool can be moved in a tool holder in a coordinated movement pattern. In particular, it has proven to be advantageous that the roll tool holder is made to automatically roll out the textured laid scrim mat according to a movement pattern allocated to the virtual illustration and coordinated therewith. In addition or alternatively, it has proven to be advantageous that an adhesive tool holder to apply adhesive according to a movement pattern allocated to a virtual illustration and coordinated therewith. Thus, roll out processes can be connected and timely optimized and pressing and gluing steps can be optimized in regard to the pressing force and glue application such as temperature or similar. Overall, the automated method can thus be varied and individually adjusted to the virtual illustration of the preform and be optimized in quality management.

In the context of another especially preferred further embodiment it is provided that the method for the production of the rotor blade is integrated into an automated storage and production method. Preferably, it is provided that laying rolls are automatically stacked and taken from a depot. For this purpose it has proven to be advantageous that each laying roll is equipped with an identification and/or safety feature which can be read without contact. An identification and/or safety feature known as an RFID element is in particular suitable.

### BRIEF DESCRIPTION OF THE SEVERAL VIEWS OF THE DRAWINGS

Exemplary embodiments of the invention will now be described below based on the drawing. It shall not illustrate the exemplary embodiments relatively, but where it serves as an explanation, the drawing is rather presented in a schematic and/or slightly distorted form. In regard to amendments to the teachings which are directly recognizable from the drawings, we refer to the applicable prior art. The drawing shows in:

FIG. 1 shows a diagram for a preferred embodiment of a production method;

FIG. 2 shows an embodiment of a laying frame with a roll tool holder and an adhesive tool holder in a first work position;

FIG. 3 shows the laying frame of FIG. 2 with a roll tool holder, which can also be used as a pressure tool holder by exchanging of the roll tool with a pressure tool—here with a press tool in form of three rolls in a second work position of the laying frame; and

FIG. 4 shows a schematic spatial detail view of a roll tool holder pursuant to a preferred embodiment.

### DETAILED DESCRIPTION

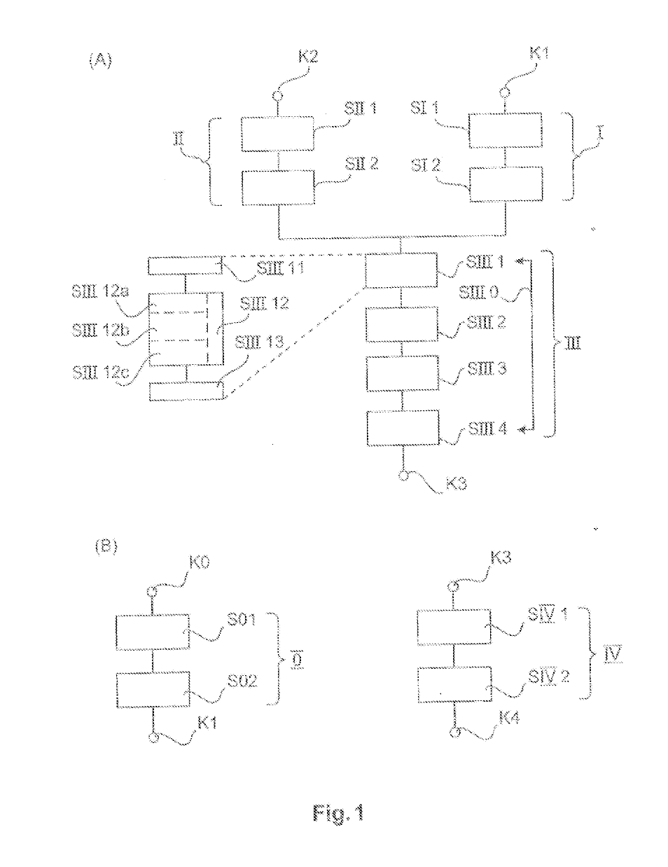

FIG. 1 shows schematically an example of a preferred process of an embodiment of a production method for a preform for a rotor blade. View (A) shows in this regard the core process for the production of the preform as a semi-finished textile product from a number of material sheets of textured laid scrim mats. View (B) illustrates that the above referenced core process can be integrated into a preferred automated process of warehousing or respectively storing while labeling the cut textured laid scrim mats. View (C) illustrates how the above referenced core process can be further developed to illustrate the preform, while subsequently performing a vacuum infusion to impregnate the preform with a resin.

In a first method segment, in reference to view (A) of FIG. 1, at first, based on a starting point K1, storage of a plurality of cut material sheets of textured laid scrim mat is set up in a first method step SI1. Storing can be set up in such a way that a single textured laid scrim mat is rolled up on a single laying roll. Storing can also be set up in such a way that a number of textured laid scrim mats are rolled up on a laying roll in rolled up form with a known sequence. Step SI1 provides identification, if applicable decryption and identification with a safety feature, of a laying roll to be used and taking the same out of the depot. In a step SI2, the laying roll taken from the depot is attached on a roll tool holder to roll out the textured laid scrim mat of the laying frame with the material sheet of a textured laid scrim mat.

In a parallel running second method segment I, starting from a crosspoint K2, a mold for the preform is provided in a laying frame. For this purpose, in a first method step SII1, the mold is attached as a negative form to a suitable mount of the laying frame. In a second step SII2, the measurements of the preform are provided in a virtual illustration in form of a CAD model or a similar data structure is provided for the mold. The virtual illustration of the preform includes in particular the position, the measurements as well as the interface and overlap areas of the material sheets of textured laid scrim mats to be used for the illustration of the preform. A corresponding line model of the above referenced edge overlap or interface areas can also serve as a template for a movement pattern, which is coordinated with the above referenced line model to specify the positioning and roll off movement of a roll tool holder as well as the positioning and dosage for an adhesive tool holder in a later method step. The above referenced line model can also serve as a template for a coordinated movement pattern for a press tool holder, with corresponding positioning for the press tool and pressure values at the positions.

In a third method segment III, the automated roll out of the textured laid scrim mat takes place in a step SIII1 on the laying frame. An automated pressing of the textured laid scrim mat to the mold or the neighboring or underlying textured laid scrim mats also takes place at the laying frame in a step SIII2. In the third segment III of the method process, the automated application of an adhesive on the rolled out textured laid scrim mat in the mold in the laying frame still takes place in step SIII3. In a step SIII4, the laying roll can again be taken out as an empty laying roll of the roll tool holder of the laying frame after the one or the number of textured laid scrim mat(s) was/were rolled out. The steps SIII1, SIII2, SIII3, SIII4 can be repeated several times in a loop SIII0, namely until all textured laid scrim mats necessary for the illustration of the preform are rolled out, covered with adhesive and pressed together. When the preform is completed, the preform can be provided in a crosspoint K3 for further processing.

The automated roll out of the textured laid scrim mat shown in step SIII1 is usually done through roll out SIII11 of the laying roll via the mold, while this is pivotably attached in the roll tool holder of the laying frame. For unwinding in SIII12 the roll tool holder specifies a corresponding lateral feed rate over the mold as well as a coordinated roll out rotating speed of the laying roll over the mold. If the material sheet on the laying roll is in relation to a first part in SIII12a rolled out in such a way that it comes to align with a beginning at the mold in the corresponding position, then this beginning can be attached to the mold and/or at the neighboring adjacent or overlapping material sheet of an already laid out textured laid scrim mat in SIII12. Subsequently, while further rolling out the laying roll, the material sheet of the laying roll in SIII12b can be completely unwound and simultaneously be inserted into the mold in the laying frame in SIII12c. In SIII13, the empty laying roll releases from the inserted material sheet.

Presently, the automated and identified storing of the material sheets of textured laid scrim mats in rolled up form on a number of laying rolls illustrated in FIG. 1B is placed in front of a crosspoint K2. For this purpose, in a prior method segment 0, starting from a crosspoint K0, each laying roll is labeled with an identification and safety feature—here in form of a RFID element. Thus, the identification and/or safety feature is retrievable without contact and applied to the laying roll in a step SOI. In a step S02, the thus labeled and re-identifiable laying roll is stored. The automated storing ends at the crosspoint K1, which can be followed by the above referenced first method segment I of the core process.

After completion of the core process, at the above referenced crosspoint K3, the preform for the further processing, i.e., in particular for a subsequent vacuum infusion to impregnate the preform with resin or another suitable polymer, such as, for example, thermoplasts or similar, can be further processed for the illustration of the matrix for the textured laid scrim mats. For this purpose, the preform is inserted into a vacuum treatment apparatus and soaked or otherwise impregnated with a matrix material in a fourth method segment IV in a step SIV1. In a further method step SIV2, a number of preforms can then be assembled into a rotor blade after the evaluation of a suitable final treatment. The method for the structural production of a rotor blade thus ends at first at crosspoint K4.

Subsequently, further measures are performed on the structure of the rotor blade, such as attaching of rotor blade connectors, lightning rods, paint or other finish of the rotor blade.

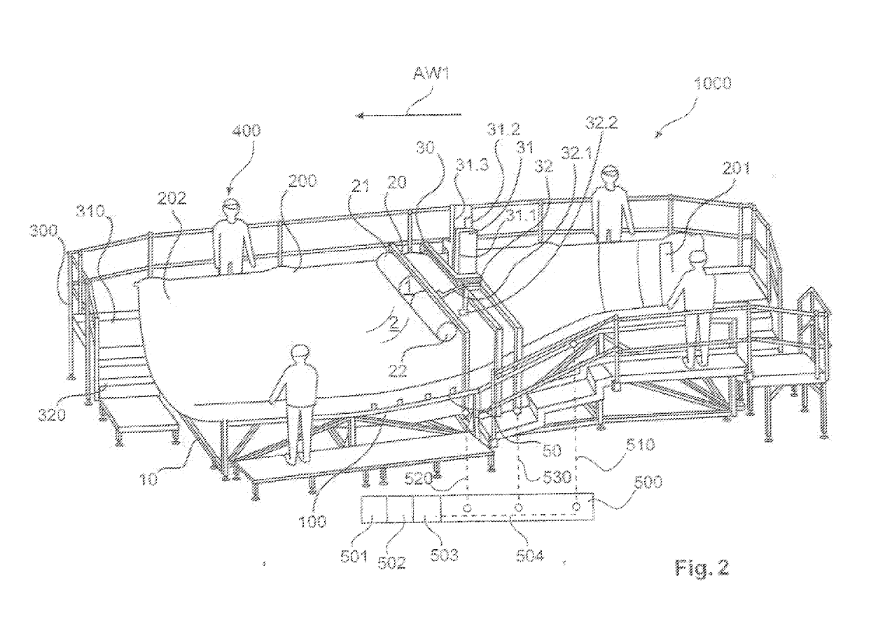

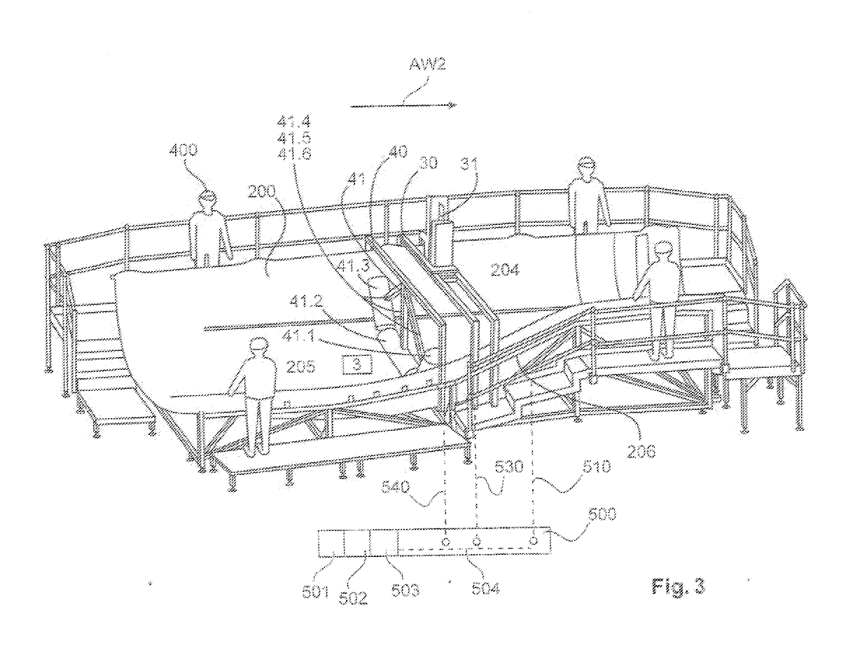

To illustrate in particular the above referenced method steps SIII1, SIII2 and SIII3, hereinafter a preferred laying frame is described in the context of an embodiment in relation to FIG. 2 and FIG. 3 with an exemplary embodiment of a roll tool holder, adhesive tool holder and press tool holder.

For this purpose, FIG. 2 shows the laying frame 100 with a mount 10, here designed as a scaffold construction, to provide a mold 200 for a preform as well as a roll tool holder 20 and an adhesive tool holder 30. Furthermore, FIG. 3 also shows a press tool holder 40. The roll tool holder 20 is used in combination with the adhesive tool holder 30 and subsequently the press tool holder in combination with the adhesive tool holder 30. In the present case of an embodiment, the roll tool holder and the press tool holder are designed as a bridge, which together with a bridge in an also slightly altered design for the adhesive tool holder 30 can be moved back and forth on a rail system 50 via mold 200, which is adjusted to the mold in form of rails. A roll tool 21 or respectively a press tool 41 can be exchangeably mounted on the bridge to form the roll tool holder 20 or respectively the press tool holder.

Furthermore, the laying frame also has a walkway 300 designed as a scaffold, which has a number of platforms 310 and stairs 320 to be adjusted in a suitable manner to the height variation of the preform or respectively the mold. On the walkway 300 there is enough room for movement and work for the operating personnel 400, which can support, observe and remotely control the automated process, if applicable, or respectively can also manually intervene in case that the compliance with the automated process makes this necessary.

The mold 200 in the embodiment shown here shows recognizably the negative form of a rotor blade, starting from a rotor blade connecting area 201, up to a third of the length of the rotor blade.

The laying frame 1000 shown here with the scaffold-like structured tool part 100, comprising the tool holders 20, 30, 40 as well as the guide system 50, comprises furthermore a symbolically shown control 500, which is designed through corresponding control connections and control lines 510, 520, 530, 540 allocated to them to control and/or regulate tool holders and the guide system in the programmed movement specifications. For this purpose, a data model for the virtual illustration 501 of the preform is provided in the control and/or regulation system 500 as well as a coordinated line or edge model to illustrate seams, overlap areas, interfaces or another structural model suitable to attach glue lines and glue areas. Such a structural model can also serve as the basis for a coordinated movement pattern 503 provided in the system 500, which serves as the basis for the output movement signals for the regulation and control lines 510, 520, 530, 540. FIG. 2 and FIG. 3 show this with corresponding data flow lines 504 to the control and regulation lines 510, 520, 530, 540.

The concept of the course of movement, which can presently be recognized from FIG. 2 and FIG. 3, includes in this embodiment, starting from a narrow side of the mold 200, here the hub side of the rotor blade 201, of simultaneously inserting in a first process—here called approach—a textured laid scrim mat through the roll tool holder of the tool arrangement 100 and of attaching adhesive in the same process through the adhesive tool holder 30 on the textured laid scrim mat at suitable glue locations—for example following the seam, interface or overlap areas pursuant to the structure model 502. Presently, the back and forth movement of the first instance is shown as AW1 in FIG. 2. A second instance AW2—here called way back or movement back—is shown in FIG. 3. While the first process runs from the hub area 201 to the end 202 of the preform or respectively of the mold 200, the second instance AW2 runs from the end 202 of the mold to the hub area 201 of the rotor blade. As shown in FIG. 3, adhesive is reapplied in the second instance AW2 on the meanwhile inserted textured laid scrim mat and the textured laid scrim mat is pressed on with a subsequent press tool holder.

It is to be understood that the here described back and forth movement with the shown first and second instances AW1, AW2, as opposing instances, is mentioned as an example. Likewise, the replacement of the roll tool of the roll tool holder 20 with a press tool of the press tool holder 40 at the end 202 of the mold to initiate the approach movement is meant as an example. Likewise, it can, for example, be provided that the tool holders 20, 30, 40 mounted next to each other in this sequence insert a textured laid scrim mat, apply adhesive and pressure it in a unidirectional first instance AW1. In an altered embodiment each process can only be preformed unidirectionally and only while inserting or pressing the textured laid scrim mat. Both possibilities of an embodiment can be combined to illustrate a preform and used as needed in regard to the individual requirements for the attachment of a textured laid scrim mat within the preform. Certain textured laid scrim mats can, for example, be inserted by a back and forth movement, others maybe only through a unidirectional process. Ultimately, the type of organization of processes as well as the corresponding movement patterns for this tool system 100 are reserved for the coordinated movement pattern 503, which takes the individual requirements of the preform based on the data model 501 or respectively the structure model 502 for the textured laid scrim mats into consideration.

Presently, the tool holder 20 comprises a roll tool 21 in such a way that a pivotable laying roll 22 can be turned or respectively advanced on the guide system with a suitable, specified unroll speed. The movement pattern 503 also specifies start and stop movements for the fixation in the context of the detailed processes in regard to step SIII1.

The advance of the adhesive tool holder 30, which holds an adhesive applicator 31, presently in the form of a drum adhesive system to apply adhesive in form of hot glue, is coordinated to this. The adhesive can be applied through a guide system 32 with presently two application arms 32.1, 32.2 on a textured laid scrim mat in the glue areas specified by the movement pattern 503. Suitable are polyurethane-based (PUR-based) hot melt adhesives. In particular, any other epoxy resin formulation of an adhesive is suitable, in particular if this is free of curing agents or solvents. The adhesive is applied by spraying or pouring at an increased temperature above 100°, while the textured laid scrim mats have a temperature which is usually not above 40°, i.e., for example at room temperature with an adhesive temperature of about 115° C. The drum melter of the adhesive applicator 31 can be provided in different embodiments and variations. A doubled drum melter system of at least two drum melters is also suited to ensure continuous operation, if one of the drum melters is emptied. As mentioned, preferred adhesives are reactive adhesives such as PUR. However, it shows that other adhesives are also suitable. In the here illustrated embodiment, the adhesive applicator 31 has a drum housing 31.1 with a suitable dosage system to operate the guide system 32, for example as suitable pressure control and three-phase motor for the dosage function of the pumps. Furthermore, the adhesive applicator has suitable robotics 31.2 for the positioning and handling of the components as well as a control and operating terminal 31.3, which additionally ensures the power supply and other operations and logistic as well as monitoring processes for the adhesive applicator 31. Via 31.3, the operating activities and machine conditions can also be remotely controlled so that the operating personnel 400 do not have to stand directly at the adhesive applicator 31.

FIG. 3 shows an automated processing situation of the preform after an inserted textured laid scrim mat in a second instance AW2. The process provides for a reapplication of the adhesive with the adhesive applicator 31 at the adhesive tool holder 30. However, this is not mandatory, but nevertheless optional, if, for example, the operating personnel 400 determines that in the first instance AW1 not enough adhesive was applied; this could be remedied in the second instance AW2, and subsequently the textured laid scrim mat previously inserted through the press tool holder 40 could be pressed to the mold 200 or previously inserted adjacent or overlapping textured laid scrim mats. A first, still partially rolled up textured laid scrim mat 1 is symbolically shown in FIG. 2. The partially rolled up and partially inserted textured laid scrim mat is shown as 2 in FIG. 2 and the completely inserted and now pressed on textured laid scrim mat is shown in FIG. 3 as 3.

The press tool 41 presently shows a number of three press rolls 41.1, 41.2, 41.3, which are in each case held pivotably on one arm 42.1, 42.2, 42.3 of a holding system 42. The arm system or respectively each of the arms 42.1, 42.2, 42.3 also show(s) corresponding actuators, which implement a pressing force of the rolls 41.1, 41.2, 41.3 to the textured laid scrim mat 3 as well as other areas of the preform in the form 200 pursuant to the movement pattern 503, if applicable.

In particular in the area of curvatures of the mold or respectively the preform, the textured laid scrim of the partially completed preform is pressed into the curvature, for example the side wall curvature 204 or respectively 206 from above or here from the side, namely in particular with press rolls 41.1, 41.3, to optimally adjust the textured laid scrim to the outline of mold 200. This applies in principle also to the mostly horizontally oriented area 205 of the mold 200. This shows a significant advantage of the automated method compared to the manual performance of a manual lamination. On the one hand it is no longer necessary that operating personnel 400 has to walk or crawl on the textured laid scrim; thus, a disadvantageous press application or press application to one spot is avoided. Furthermore, the strongly curved and high areas, such as the areas 204, 206, can now in mold 200 be processed with the same quality as a mostly horizontal part 205 of the mold 200; differences in accessibility specified by the different curvature or orientation thus no longer have an impact on the optimal design of the textured laid scrim; that impacts the latter namely by application of adhesive and pressure conditions.

Ultimately, when integrating a CAD system as well as specifying the movement pattern 503 and the structural model 502 based on a CAD data model 501 the system has significant advantages in the expansion of the quality management and individual handling of each individual preform or respectively mold 200. Due to the presently preferred described method automation and constructive specification of the laying frame 1000, the textured laid scrim with a number of material sheets of the textured laid scrim mats can thus be adjusted in an optimal manner to the outline of the preform or respectively of the mold 200. Furthermore, it shows that the here described embodiment can be integrated especially well in a larger automated storing and taking out of storage process as well as an overall automated rotor blade production.

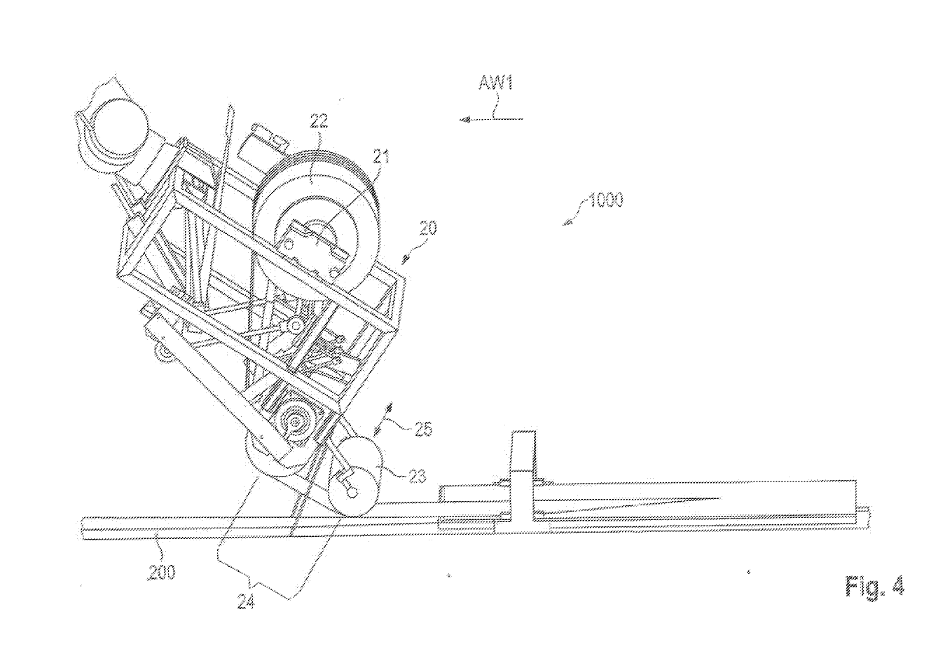

FIG. 4 illustrates a part of the apparatus according to one embodiment of the invention 1000 (laying frame) in a spatial side view. FIG. 4 shows a roll off process of the textured laid scrim mat in the direction AW1. Shown is, in particular, a variable of the roll tool 21 on the tool holder 20 housed on a robot arm which can be moved around multiple axes. The rolled off laying roll 22, which is held by the roll tool 21, is redirected by a dancer roll 23 before it reaches the mold 200. A section of the textured laid scrim mat 24 sags between the laying roll 22 and the mold 200. The dancer roll 23 is movable in the direction of the arrow 25, in particular pivotable and/or translationally movable, to make it possible to vary the degree of the sag in section 24. Optionally, the tool holder 20 (not illustrated) has a sensor means to record the tensile stress. The (not illustrated) sensor means either record the distance to the textured laid scrim mat in section 24 from a stationary attachment on the tool holder 20 or a position of the dancer roll 23. Preferably, the roll tool 21 and a drive of the dancer roll 23 are connected to the control 500 in a signal conducting manner (data connection not illustrated) to regulate the roll off speed of the roll tool 21 and the position of the dancer roll 25 coordinated to each other in such a way that the tensile stress, which affects the textured laid scrim mat, remains in a predetermined range. In the pre-tests, the predetermined range of the tensile stress has to be selected in such a way that no creasing occurs dependent on the material of the textured laid scrim mat, but also no tensile stress occurs that is so high that a forming of the textured laid scrim mat to the mold is made more difficult or prevented.

1. A method of producing a rotor blade, the method comprising:
placing a mold in a laying frame;
placing at least one textured laid scrim mat of a material sheet in rolled up form on a laying roll;
sending a first signal that causes the laying roll to rotate such that the textured laid scrim mat unrolls from the laying roll and simultaneously inserts the textured laid scrim mat in the mold in the laying frame; and
sending a second signal that causes application of a glue or adhesive on the textured laid scrim mat in the mold in the laying frame.

2. The method according to claim 1, further comprising at least one of the following steps:
attaching at least one textured laid scrim mat to the mold;
pressing the inserted textured laid scrim mat against the mold in an edge area, an overlap area, an adjacent area, or seam provided between the inserted textured laid scrim mat and another textured laid scrim mat;
attaching the laying roll to a roll tool holder of the laying frame;
dispensing the glue or the adhesive from an adhesive applicator in an adhesive tool holder of the laying frame;
attaching a first textured laid scrim mat to a second textured laid scrim mat in the mold through the application of the glue or adhesive; and
repeating the steps of sending first and second signals for a number of material sheets of textured laid scrim mats to form a unidirectional, bidirectional or multidirectional layer with a number of textured laid scrim mats.

3. The method according to claim 1, wherein the first and second signals are sent simultaneously, wherein the laying roll simultaneously presses the texture laid scrim mat against the mold as the textured laid scrim mat unrolls.

4. The method according to claim 1, wherein unrolling the textured laid scrim mat and the application of the glue or adhesive is performed in a back and forth movement of a tool holder.

5. The method according to claim 1, wherein the textured laid scrim mat is unrolled starting from a narrow side of the mold.

6. The method according to claim 1, further comprising:
providing a virtual illustration of the preform, wherein movement of a roller tool holder to unroll the textured laid scrim mat and movement of an adhesive tool holder to apply the glue or adhesive is performed according to movement patterns allocated to the virtual illustration.

7. The method according to claim 1, further comprising:
automated storing and removal of laying rolls with at least one of an identification feature and safety feature, wherein the identification or safety feature includes a RFID element that is readable without physical contact.

8. An apparatus for producing a rotor blade, the apparatus comprising:
a controller configured to generate first and second control signals;
a mount adapted to provide a mold for forming a preform in a laying frame;
a roll tool holder configured to hold a textured laid scrim mat of a material sheet in rolled up form on a laying roll and to unroll the textured laid scrim mat in the mold in the laying frame in response to receiving the first control signal from the controller;
an adhesive tool holder configured to dispense an adhesive on the textured laid scrim mat in the mold in the laying frame in response to receiving the second control signal from the controller.

9. The apparatus according to claim 8 further comprising a pressure tool holder configured to press the inserted textured laid scrim mat against the mold.

10. The apparatus according to claim 8, wherein the roll tool holder includes a replaceable roll tool, and further comprising an exchangeable press tool that includes a press roll, a barrel, or sensor.

11. The apparatus according to claim 8, further comprising sensor means that are movable together with the tool holder and are adapted to record a tensile stress applied to the rolled off, not yet pressed sections of the textured laid scrim mat.

12. The apparatus according to claim 11, wherein the sensor means comprise at least one distance sensor adapted to record a sag of the rolled off, not yet pressed sections of the textured laid scrim mat.

13. The apparatus according to claim 11, wherein one or several dancer rolls that are arranged on the tool holder in such a way that the textured laid scrim mat that is rolled off from the laying roll is redirected at least once before it is pressed against mold, whereby the one or several dancer rolls include sensor means to record tension that affect the rolled off, not yet pressed sections of the textured laid scrim mat.

14. The apparatus according to claim 9, wherein the press tool holder includes at least one arm for a press tool that includes at least one of a press, a roll, a barrel, and a sensor.

15. The apparatus according to claim 14, wherein the at least one arm of the press tool holder is arranged on the tool holder and pivotable about at least one axis in that the at least one arm is adapted to hold the press tool pivotably about one or more axes.

16. The apparatus according to claim 14, wherein at least one of the press tool holder and the at least one arm includes sensor means adapted to record the exercised pressing force and are movable relative to the mold such that their distance to the mold can be readjusted dependent on the recorded pressing force by increasing or decreasing the distance between the mold and the press tool to keep the pressing force in a predetermined range.

17. The apparatus according to claim 8, wherein the controller is configured to provide a virtual illustration of the preform.

18. The apparatus according to claim 17, wherein the controller is established for an automated storing and removal of laying roll with an identification and/or safety feature which can be read without physical contact.
